(19) United States
(12) Patent Application Publication
(10) Pub. No.: US 2013/0201688 A1
(43) Pub. Date: Aug. 8, 2013

(54) Adjustable Beam Lamp

(71) Applicant: Karen F. Glass, Andover, MA (US)

(72) Inventor: Karen F. Glass, Andover, MA (US)

(21) Appl. No.: 13/364,989

(22) Filed: Feb. 2, 2012

(51) Int. Cl. F21V 19/02

(52) U.S. Cl. 362/285

(57) ABSTRACT

An lamp having an adjustable beam is provided. The lamp has a base, a stem extending from the base, a light source, and a light source housing. The light source housing is configured to allow a beam of light from the light source to be adjusted from a broad beam, to a narrow, focused beam, and varying beams in between.

### BACKGROUND OF THE INVENTION

1. Field of the Invention

The present invention relates generally to lighting systems. More particularly, the present invention relates to a lamp with an adjustable beam.

2. Description of Related Art

Typical desk, table and floor lamps are configured to provide lighting in all directions. Often shades or other features may be disposed about the light source to temper and soften the light output. Moreover, some lamps have the ability to swing in different directions to bring a light source closer or farther away. However these movable lamps provide only minimal movement and direction of the light, and can be cumbersome to adjust.

In many situations, a typical lamp does not provide sufficient lighting for detailed inspection of an item. In these cases a directed beam of light at the item is preferable. This directed beam requires a second light source to supplement a traditional lamp, such as flashlight.

Therefore, what is needed is a lamp that may provide broad lighting for room-illuminating uses that also may provide directed light for situations requiring an intense, focused beam of light.

### SUMMARY OF THE INVENTION

The subject matter of this application may involve, in some cases, interrelated products, alternative solutions to a particular problem, and/or a plurality of different uses of a single system or article.

In one aspect, an adjustable beam lamp is provided. The lamp comprises a base, and a stem attached to and extending from a top surface of the base. The stem may have an adjustable portion which allows a distal end of the stem to be directed in varying directions. Further, a light source is attached to the distal end of the stem. A light source housing of the lamp surrounds the light source, the light source housing having a body, an adjuster movably attached to the body, and a lens positioned over the light source. The adjuster may be moved to adjust the lens which in turn adjusts the beam of the lamp from the light source.

In another aspect, a method of adjusting a beam of an adjustable beam lamp is provided. The method may comprise the steps of activating the adjustable beam lamp by a switch, adjusting a direction of a light source by manipulating an adjustable portion of a stem of the lamp, and adjusting the beam of the light source by sliding an adjuster longitudinally along a body of a light source housing.

### BRIEF DESCRIPTION OF THE DRAWINGS

FIG. 1 provides a perspective view of an embodiment of the lamp.

FIG. 2 provides an embodiment of a light source housing.

FIG. 3 provides a embodiment of a light source housing with the adjuster in an extended position.

FIG. 4 provides a cross sectional view of one embodiment of the light source housing.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns an adjustable beam lamp. The lamp may comprise a base, which provides a stabilizing structure to the lamp, a light source, a housing surrounding the light source which allows adjustment of a beam of the light source, and a stem which connects the light source to the base. In varying embodiments, the lamp may be configured as a desk lamp, table lamp, wall mounted lamp, clip lamp, ceiling lamp, track mounted lamp, or floor lamp, among other things.

The present invention solves the common problem of needing two separate light sources to provide broad illuminating-type beams and narrow focused beams of light. The present invention achieves this by allowing beams from a light source to be broad or focused depending on adjustment. The present invention may be sold in retail stores providing office or home supplies. Further, the present invention may be sold online, through catalogs, home shopping distributors, or in any other mode of distribution. Moreover, the present invention may be provided assembled, or may require assembly.

The base of the lamp may be configured to rest on a flat surface, provide stability for the lamp, and provide a central structure for the lamp. The base may be constructed of any material. For example, materials of which the base may be constructed may include metal, wood, plastic, ceramic, composites, and the like. In one embodiment, the base may be formed to be substantially hollow, and may house components of the lamp. Preferably, the base has a mass sufficient to provide stability for the lamp, preventing it from being easily knocked over.

The base may be of any shape and size that is practical for a lamp. In one embodiment, the base may have a substantially circular cross section, and substantially cylindrical shape. In another embodiment, the base may have a substantially rectangular cross section and a substantially rectangular prism shape.

A stem may extend from a top surface of the base. The stem extends from the base to an extent that a light source is sufficiently elevated and extended away from the base. The size and shape of the stem may vary depending on the type of lamp utilized. For example a desk lamp may have a shorter and narrower stem than a floor lamp.

The stem may be formed of any material. Materials of which the stem may be constructed may include metal, wood, plastic, ceramic, composites, and the like.

The stem may be comprised partially of an adjustable portion. The adjustable portion may be any structure that allows a light source attached at an end of the stem to be moved and directed in more than one direction. In one embodiment, the adjustable portion may be a hinged attachment. In another embodiment, the adjustable portion may be a flexible metal tube, sometimes referred to as a “snake” tube. In these embodiments, the adjustable portion may allow the light source to be easily directed as desired to provide light to a desired location.

A light source may be attached to the stem. In one embodiment, the light source may be attached to the adjustable portion of the stem. The light source may be any suitable light source capable of providing room lighting. Light sources may include, but are not limited to light emitting diodes (LED), compact fluorescent lights (CFL), halogen lamps, and incandescent bulbs. In a preferred embodiment, the light source produces wavelengths substantially in the visible spectrum.

A power source is connected to the light source to provide electric power to it. The power source may be connected to the light source in any manner. In one embodiment, the power source may be a power cord connected to a wall outlet. The power cord may enter into the base, extend through an interior of the stem, and connect to the light source. In this embodiment, the power source is concealed within the lamp. In other embodiments, the power source may connect directly to the light source externally from the base or stem. In one embodiment, the power source may be an insulated wire that may connect at a first end to a power outlet, and at a second end connect to the light source. The power outlet may be a traditional wall outlet, car outlet, or other power outlet. In still another embodiment, the power source may be a battery or batteries positioned within or outside of the base. In this embodiment, a power cord may extend from the battery, through the stem to the light source.

The light source may be disposed within a light source housing. The light source housing may surround the light source, and provide the structure to allow beam adjustment. In one embodiment, the light source housing may be connected to the adjustable portion of the stem.

In one embodiment, the light source housing may be comprised of a body, an adjuster, and a lens. The adjuster may move in relation to the body, such that the lens and adjuster provide broad or directed light.

The light source housing may be attached to the stem in any manner such as clamping, screwing, adhering, and the like. In one embodiment, the body of the light source housing may be crimped into the adjustable portion of the stem. In another embodiment, the adjustable portion may be formed integrally with the body.

In one embodiment, the body may form a back stop, a front stop and a sliding region. In this embodiment, the adjuster may be slideably attached to the body such that it may move longitudinally along the sliding region of the body. The back stop and front stop provide end points for movement of the adjuster.

In a further embodiment, a frictional interference between an inner surface of the adjuster and the sliding region of the body may allow the adjuster to remain in position until intentionally manipulated by a user. In one embodiment, this friction may be sufficient to hold the adjuster in place against a force of gravity.

In another embodiment, the body may form threaded grooves. In this embodiment, the adjuster may be attached to the body via a threaded screw attachment. The adjuster may be rotated to move it longitudinally along the body, such that the lens and adjuster may provide broad or directed light. In this embodiment, the body may form a front stop and a back stop to prevent over or under rotation of the adjuster thus limiting its longitudinal movement.

It should be understood that in the above embodiments, the adjuster may be positioned in a nearly infinite number of different positions. Accordingly, this adjustability results in a broad range of beam focuses.

A lens may be attached to the adjuster. The lens may be any substantially translucent or transparent material, and may be of any shape and size that may allow light to pass through it. The movement of the adjuster may bring the lens closer or farther from the light source, and as such may broaden or narrow a beam of light emitted from the lamp.

The lens may be of any type or style that may focus, scatter, dim or negligibly interfere with light passing through it. In one embodiment, the lens may have a concave front surface and a flat rear surface. In another embodiment, the lens may have a convex front surface and flat rear surface. In yet another embodiment, the lens may be concave on both sides. In still another embodiment, the lens may be convex on both sides. In yet another embodiment, the lens may be convex on one side, and concave on the other side. It should be understood that lens configuration may control beam breadth or focus as much as the adjuster, if not more so.

In one embodiment, the lens may be attached directly to the adjuster. In another embodiment, the lens may be attached to a lens mount, the lens mount in turn being attached to the adjuster. The lens may be attached to the lens mount in any way. In one embodiment, the lens may be adhered to the lens mount. The lens mount may be attached to the adjuster in any manner. In one embodiment, the lens mount may be threadedly attached to the adjuster.

The lamp may further comprise a switch. The switch may allow electronic communication from the power source to the light source. The switch may be positioned on any portion of the lamp that provides convenient access to turn the lamp on or off. In one embodiment, the switch may be on the base. In another embodiment, the switch may be on the stem. In still another embodiment, the switch may be on the light source housing. In yet another embodiment, the switch may be on the power cord.

Further, the switch may be of any type known in the art of switches. For example, the switch may be an on off switch, a dimmer switch, a multiple stage switch, and the like.

In an embodiment where the lamp is configured as a desk lamp, the size of the base, stem, light source, and light source housing may be all sized and configured to fit conveniently on a desk. For example, the base may have a relatively small footprint. In one embodiment, the base may be circular and may have an approximately six inch diameter. Moreover, the stem may be relatively short for desk lamp embodiments. In one embodiment the stem may be approximately 18-24 inches long. Further, the light source may be dimmer for desk lamp embodiment than a light source of a lamp providing lamp to a broader area, such as floor lamp embodiment.

In an embodiment where the lamp is configured as a floor lamp, the size of the base, stem, light source and light source housing may be sized and configured to be large enough to provide lighting to a room sized area, while maintaining stability. For example, the base may have a large footprint to provide stability for a tall stem of the lamp. In one embodiment, the base may be circular and may be approximately 12 inches in diameter. Moreover, the stem may be relatively tall, allowing the light source to be approximately head level. In one embodiment, the stem may be approximately 5 to 6 feet in height. Further the light source may be bright enough to substantially illuminate a room when the adjuster is configured to provide a broad beam.

The adjustable beam lamp may be used in any number of manners to provide broad and/or narrow beams of light. In one embodiment, the adjustable beam lamp configured as a desk lamp with a slideable adjuster may be used. The lamp may be switched to an on position, allowing electric communication between the power source and the light source. A user may manipulate the adjustable portion of the stem to direct the light source to its intended position. In the event that a narrow beam is desired, the user may slide the adjuster longitudinally away from the light source (in embodiments where such adjuster movement narrows the beam). In the event that a broad beam is desired, the user may slide the adjuster longitudinally towards the light source.

In still another embodiment, the adjustable beam lamp may be configured on track lighting. In this embodiment, the adjustable beam lamp may be adjustable in direction and beam focus to direct lighting to a wide variety of targets. For example, a track light of this embodiment may be directed to a large wall hanging, and the beam could be broadened to cast light on the entire hanging. Alternatively, the same lamp mounted on the track could be adjusted to cast light on a smaller vase by narrowing the beam. As such, embodiments of the adjustable beam lamp mounted to a track light may provide a plurality of lighting options depending on the target to be illuminated.

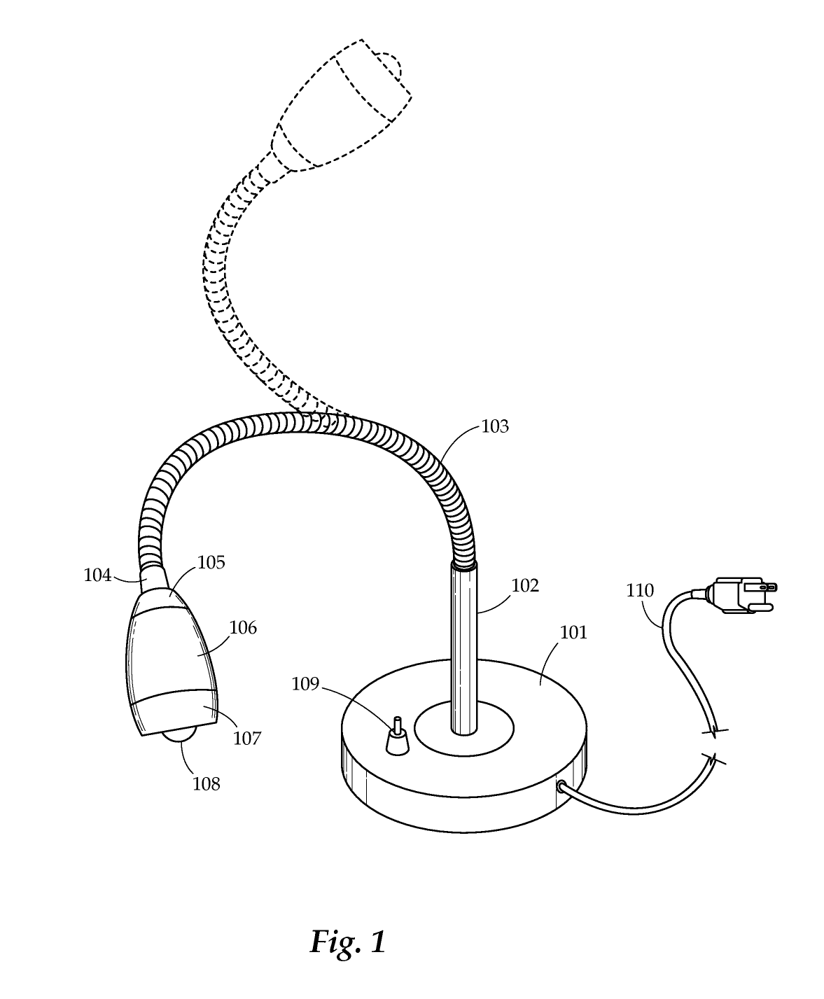

Turning now to FIG. 1 a perspective view of an embodiment of the lamp is provided. The lamp has a base 101 at its bottom which provides stability to the lamp. A stem 102 extends from a top surface of the base 101. A switch 109 is positioned on the base 101 and allows a light source of the lamp to be turned on and off. The stem 102 has an adjustable portion 103 which is flexible and allows a distal end of the stem to be adjusted in various directions. A light source housing 105 is attached to the distal end of the flexible portion 103 by a connector 104. The light source housing 105 forms a body, and an adjuster 106. The adjuster 106 may be moved longitudinally along the light source housing 105 body. Longitudinal movement of the adjuster 106 is limited in one direction by the light source housing 105 which forms a back stop, and in another direction by the body which also forms a front stop (not shown). A lens mount 107 is attached to the adjuster 106. A lens 108 is attached to the lens mount 107. A power source 110 in the form of an electric cable extends from a side of the base 101.

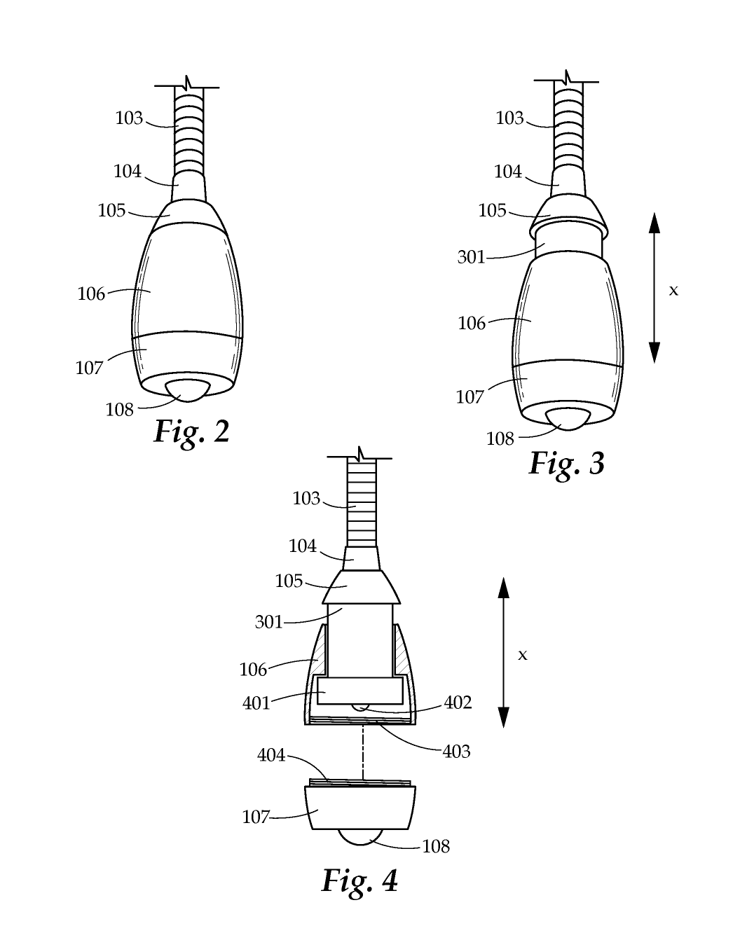

FIG. 2 shows an embodiment of a light source housing. The light source housing 105 is attached to a distal end of a stem adjustment portion 103 by a connector 104. An adjuster 106 is slideably mounted to the body and longitudinally moveable thereon. A lens mount 107 is removably attached to the adjuster 106. A lens 108 is mounted to the lens mount 107.

FIG. 3 shows an embodiment of a light source housing with the adjuster in an extended position. The light source housing 105 is attached to a distal end of a stem adjustment portion 103 by a connector 104. An adjuster 106 is slideably mounted to the body and longitudinally moveable thereon in the ‘x’ direction. In this embodiment the adjuster 106 is in an extended position, exposing a slide portion 301 along which the adjuster 106 may slide. A lens mount 107 is removably attached to the adjuster 106. A lens 108 is mounted to the lens mount 107.

FIG. 4 provides a cross sectional view of one embodiment of the light source housing. The light source housing 105 is attached to a distal end of a stem adjustment portion 103 by a connector 104. An adjuster 106 is slideably mounted to the body and longitudinally moveable thereon in the ‘x’ direction. In this embodiment the adjuster 106 is in an extended position, exposing a slide portion 301 along which the adjuster 106 may slide. The adjuster is limited in movement by a front stop 401 formed by the housing 105. A light source 402 is positioned on a front of the light source housing 105. A lens mount 107 is threadedly attachable to the adjuster 106 by a threaded portion 404 of the lens mount 107 and a threaded portion 403 of the adjuster 106. A lens mount 107 is removably attached to the adjuster 106. A lens 108 is mounted to the lens mount 107.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. An adjustable beam lamp comprising:
a base;
a stem, a proximal end of the stem attached to a top surface of the base;
an adjustable portion of the stem, the adjustment portion allowing a distal end of the stem to be directed in a plurality of directions while the proximal end of the stem remains stationary;
a light source positioned at the distal end of the stem;
a light source housing disposed about the light source, the light source housing comprising a body attached to the adjustment portion of the stem, an adjuster movably attached to the body, and a lens positioned ahead of the light source; and
wherein the adjuster is longitudinally movable along the body, allowing the lens to be moved from a first position near the light source to a second position away from the light source, the body retaining the adjuster on the body.

2. The adjustable beam lamp of claim 1 wherein the adjuster is slideably attached to the body of the light source housing.

3. The adjustable beam lamp of claim 2 wherein the body of the light source housing further comprises a back stop, a front stop, and a slide portion, the back stop preventing the adjuster from moving beyond the first position, the front stop preventing the adjuster from moving beyond the second position, the slide portion being formed between the front stop and the back stop, and defining a region along which the adjuster may slide.

4. The adjustable beam lamp of claim 3 wherein an interference between the adjuster and the slide portion of the body creates a quantity of friction sufficient to retain the adjuster in a position against a force of gravity.

5. The adjustable beam lamp of claim 1 wherein the adjuster is screw mounted to the body of the light source housing.

6. The adjustable beam lamp of claim 1 further comprising a power cord, the power cord being disposed through an aperture formed by the base, being disposed through a hollow portion of the stem, and being connected to the light source.

7. The adjustable beam lamp of claim 6 further comprising a switch attached to the lamp, the switch providing electronic communication between the power cord and the light source when in a first position, and preventing electronic communication between the power cord and the light source when in a second position.

8. The adjustable beam lamp of claim 1 wherein the lens has a convex outer surface.

9. The adjustable beam lamp of claim 1 wherein the lens is attached to a lens mount, the lens mount being removably connected to the adjuster.

10. The adjustable beam lamp of claim 9 wherein the lens is adhered to the lens mount.

11. The adjustable beam lamp of claim 9 wherein the lens mount is threadedly connected to the adjuster.

12. The adjustable beam lamp of claim 1 wherein the lens is directly attached to the adjuster.

13. The adjustable beam lamp of claim 1 wherein the adjustable portion of the stem is a snake tube.

14. The adjustable beam lamp of claim 1 wherein the lamp is constructed and arranged as a desk lamp, and wherein the base is sized and configured to be set on a desk.

15. The adjustable beam lamp of claim 1 wherein the lamp is constructed and arranged as a floor lamp, and wherein the base is sized and configured to be set on a floor.

16. The adjustable beam lamp of claim 1 wherein a beam of the light source is focused when the adjuster is in the second position away from the light source.

17. The adjustable beam lamp of claim 1 wherein a beam of the light source is focused when the adjuster is in the first position near the light source.

18. A method of adjusting a beam of an adjustable beam lamp comprising the steps of:
activating the adjustable beam lamp by a switch;
adjusting a direction of a light source by manipulating an adjustable portion of a stem of the adjustable beam lamp while keeping a base of the adjustable beam lamp stationary; and
adjusting a beam of the light source by sliding an adjuster longitudinally along a light source housing body to which the adjuster is attached.

19. The method of adjusting a beam of an adjustable beam lamp of claim 18 comprising the step of re-adjusting the beam of the light source by sliding the adjuster longitudinally along the body to which the adjuster is attached until the adjuster reaches a back stop of the base.

20. An adjustable beam lamp comprising:
a base;
a stem, a proximal end of the stem attached to, and extending from, a top surface of the base;
an adjustable portion of the stem, the adjustment portion formed as a snake tube and allowing a distal end of the stem to be directed in a plurality of directions while the proximal end remains stationary;
a light source positioned at the distal end of the stem;
a light source housing disposed about the light source, the light source housing comprising a body attached to the adjustment portion of the stem, an adjuster slideably attached to the body, and a lens positioned ahead of the light source, the lens having a convex surface;
wherein the adjuster is longitudinally slideable along the body, allowing the lens to be moved from a first position near the light source to a second position away from the light source;
wherein the body of the light source housing further comprises a back stop, a front stop, and a slide portion the back stop preventing the adjuster from moving beyond the first position, the front stop preventing the adjuster from moving beyond the second position, the slide portion being between the front stop and the back stop, and defining a region along which the adjuster may slide;
wherein an interference between the adjuster and the body creates a quantity of friction sufficient to retain the adjuster in a position against a force of gravity;
a power cord, the power cord being disposed through an aperture formed by the base, disposed through a hollow portion of the stem, and connected to the light source;
a switch attached to the lamp and providing electronic communication between the power cord and the light source; and
wherein the lens is attached to a lens mount, the lens mount being connectable to the adjuster.
